(19) United States
(12) Patent Application Publication
(10) Pub. No.: US 2015/0328914 A1
(43) Pub. Date: Nov. 19, 2015

(54) METHOD AND DEVICE FOR PRODUCING A PANORAMA BOOK AND A BOOK-BLOCK OF A PANORAMA BOOK AND FOLDING APPARATUS FOR FOLDING SHEETS IN HALF USED THEREIN

(71) Applicant: UNIBIND LIMITED, Nicosia (CY)

(72) Inventor: Guido PELEMAN, Antwerpen (BE)

(73) Assignee: UNIBIND LIMITED, Nicosia (CY)

(21) Appl. No.: 14/705,064

(22) Filed: May 6, 2015

(30) Foreign Application Priority Data
May 13, 2014 (BE) 2014/0355

(51) Int. Cl. B42C 13/00; B65H 45/12; B65H 37/06

(52) U.S. Cl. CPC B42C 13/003; B65H 37/06; B65H 45/12

(57) ABSTRACT

A folding apparatus for folding sheets in half (8), characterised in that the folding apparatus (1) includes a baseplate (2) with an end stop (7a, 7b, 7c) for aligning a sheet (8) to be folded and a pressing element (3) that is movable with respect to the baseplate (2) in order to enable a sheet (8) to be folded in half, that is placed with two opposite sides against the end stop (7a, 7b, 7c), by bringing the pressing element (3) to the baseplate (2) in order to make such a fold (10).

### BACKGROUND OF THE INVENTION

1. Field of the Invention

The present invention relates to a method and device for producing a ‘panorama book’ and a book-block of a panorama book and folding apparatus for folding sheets in half used therein.

2. Background

It is characteristic of a panorama book that the picture or pictures that are to be seen when the book is opened run seamlessly across the central fold from one page to the next.

In this way wider panoramic pictures can be shown without interruption over the two pages.

It is known that to compose such a panorama book, the starting point is a picture that is made on a sheet of paper or similar with the dimensions of a double page over which the picture must extend.

The pages with the pictures are then folded in half and bonded back-to-back against one another in this folded state, and inserted and bonded as a book-block in a hard folder or similar.

A folding machine is used for the half folding.

With a first type of folding machine a crease is pressed into the sheet of paper or similar to be folded with a slat, and the sheet is then folded later along this creased zone.

With a second type of known folding machine the sheet to be folded is pushed between two rollers whereby a sharp fold occurs.

In both cases the fold is never positioned perfectly in the centre, whereby deviations of more than one to even a few millimetres occur.

This results in the disadvantage that the folded sheets in the book-block are never perfectly aligned to one another and that the edges of the book-block obtained are never completely straight because some sheets protrude along the edges somewhat more or less than other sheets.

A disadvantage is that this requires the edges of the book-block to be subsequently cut in order to make them straight and to obtain the exact dimensions of the book-block.

The post-cutting requires time and thus costs, and an extra investment in a cutting machine, and also requires the necessary space to set up such a cutting machine and safely protect it against unauthorised use.

This means that this technique is only reserved for application in an industrial production environment and is not very suitable for application in a small to medium-sized company.

In addition, for gluing the sheets folded in half together, an expensive industrial machine is required that is not suitable either for application in a small to medium-sized company.

Moreover, the folded sheets must be perfectly stacked for bonding, as otherwise this would require the edges of the book-block having to be subsequently cut, resulting in the above-mentioned disadvantages.

### SUMMARY OF THE INVENTION

The purpose of the present invention is to provide a solution to the aforementioned and other disadvantages.

The object of the present invention is a folding apparatus for folding sheets in half, whereby the folding apparatus comprises a baseplate with an end stop for aligning a sheet to be folded and a pressing element that is movable with respect to the baseplate in order to enable a sheet to be folded in half, that is placed with two opposite sides against the end stop, by bringing the pressing element to the baseplate in order to make such a fold.

An advantage is that such a folding apparatus will enable sheets to be folded in half whereby the fold will always be exactly in the centre by positioning the sheet to be folded in half with two opposite sides against the end stop and thereby aligning it.

‘Exactly’ also means ‘as good as exactly. This means that the any deviations are not visible to the naked eye and that subsequent cutting is not necessary.

In practice this means that any deviation is a maximum of 0.1 mm.

An additional advantage is that such a folding apparatus is very compact and can be used in small to medium-sized companies or commercial zones.

It is a type of hand tool that can be operated manually, in contrast to the known folding devices that are generally larger machine-operated devices.

Moreover, the use of the folding apparatus is very simple and very safe and trained personnel are not required for it.

Preferably the end stop is at the location of the hinge.

This has the advantage that sheets to be folded in half can be positioned with an edge against the end stop, so that the fold formed is always at the same location in successive sheets to be folded in half.

This will ensure that the book-block formed with these sheets folded in half can be aligned exactly and thereby does not have to be subsequently cut, such that time can be saved. Moreover expensive, bulky and relatively hazardous cutting machines are no longer required.

The invention also concerns a method for producing a book-block of sheets folded in half laminated on one another for a panorama book, whereby use is made of a folding apparatus according to the invention for folding sheets in half, and a laminating device that is provided with a hotplate that can be lowered and a slide in which an aligning plate can be affixed with end stops for aligning sheets folded in half with respect to one another and with a pressure plate consisting of a hard plate that is provided on one side with a soft layer, whereby the method comprises the following steps:
the production of the sheets folded in half for the book-block using the folding apparatus;
the laying of the sheets folded in half in the aligning plate with a film between two successive sheets folded in half each time, whereby this film is provided on both sides with a layer of hotmelt adhesive, ensuring that the sheets and films are aligned with respect to one another on one another using the end stops;
the placing of the pressure plate in the aligning plate with the soft layer towards the sheets, ensuring that the pressure plate is aligned with the sheets folded in half using the end stops;
the placing of the aligning plate with the sheets folded in half, films and pressure plate in the slide of the laminating device, ensuring that the pressure plate is placed against the base of the slide;
the lowering of the hotplate, whereby the hotplate makes contact with the aligning plate, so that the hotmelt adhesive melts and the sheets folded in half are laminated on one another;
the raising of the hotplate back upwards;
taking the aligning plate with the sheets folded in half laminated to one another and the pressure plate out of the slide;
the removal of the book-block produced from the aligning plate.

Such a method has the advantage that in the book-block obtained, the sheets folded in half laminated on one another are perfectly aligned, such that post-cutting of the book-block is no longer necessary.

Moreover, use is made of simple and safe equipment or apparatus, such that qualified or specially trained personnel are not required.

It is important to note that a cooling plate is preferably affixed on top of the laminated sheets folded in half during normal use, i.e. when the hotplate is lifted upwards and the slide is withdrawn after approximately ten minutes.

However, when the hotplate continues to rest on the sheets folded in half, and the heating is switched off after a certain time, it can act as a cooling plate. Only when the hotplate is lifted upwards after approximately one hour, and the aligning plate with the sheets folded in half laminated to one another and the pressure plate are taken out of the slide, is the cooling plate no longer required.

The invention also concerns a method for producing a panorama book starting with a book-block produced according to the invention and a hard cover, and making use of a positioning element that comprises a positioning plate that is provided on two opposite edges with protruding ribs, whereby the distance between the protruding ribs is equal to the width of a hard cover, whereby on one side of the positioning plate the transition from the positioning plate to the protruding ribs is stepped, whereby the distance between the steps is equal to the width of the book-block, whereby one edge of the positioning plate that extends transversely on the ribs may be provided with an end stop, on the side of the positioning plate with the stepped transition, whereby the method comprises the following steps:
the opening of the hard cover;
the placing of the positioning element on the hard cover, ensuring that the cover is between the protruding ribs, with the side with the stepped transition oriented upwards, and that an edge of the positioning plate is aligned with an edge of the hard cover;
the introduction of the book-block ensuring that the book-block is between the steps and that the book-block comes against the transition if need be;
the closing of the hard cover and placing the set in an open tray that is provided with upright edges and whose dimensions correspond to the hard cover;
the fastening of the book-block in the hard cover by means of at least one adhesive strip that is provided either on an endpaper of the book-block, or on an inside page of the hard cover.

Such a method has the advantage that the book-block is positioned exactly or as good as exactly with respect to the hard cover. The method is also very simple and can be implemented by unqualified personnel.

The invention also concerns a device for producing a panorama book, whereby this device is provided with:
a folding apparatus according to the invention for folding sheets in half;
an aligning apparatus for aligning sheets folded in half to one another to form a book-block, whereby this aligning apparatus comprises an aligning plate with end stops for aligning sheets folded in half with respect to one another on one another, and a pressure plate consisting of a hard plate that is provided with a soft layer on one side, whereby the pressure plate is suitable for being introduced in the aligning plate; and
a positioning element for positioning the book-block in a hard cover, whereby this positioning element comprises a positioning plate that is provided with protruding ribs on two opposite edges, whereby the distance between the protruding ribs is equal to the width of the hard cover, whereby on one side of the positioning plate the transition from the positioning plate to the protruding ribs is stepped, whereby the distance between the steps is equal to the width of the book-block, whereby one edge of the positioning plate that extends transversely on the ribs is provided with an end stop if need be, on the side of the positioning plate with the stepped transition.

Such a device has the advantage that it is a combination of compact apparatuses that can be operated by hand and used in small companies or commercial zones.

Moreover, the use of the device is very simple and very safe and qualified personnel are not required for it.

Such a device can be used in a method according to the invention for producing a panorama book.

An advantage of such an aligning apparatus of the aforementioned device is that it enables the sheets folded in half that must be laminated back-to-back on one another to be aligned very precisely to one another so that these sheets are perfectly or exactly positioned.

‘Perfectly’ also means ‘as good as perfectly’. This means that the deviations are almost invisible to the naked eye.

A positioning element of the aforementioned device according to the invention will enable the book-block to be positioned exactly or as good as exactly in the hard cover before fastening the book-block in the hard cover, for example by gluing.

Due to the protruding ribs and the stepped transition, the alignment will be done automatically, as it were. Moreover, the use of the positioning element is very simple and very safe so that qualified personnel are not required.

### BRIEF DESCRIPTION OF THE DRAWINGS

With the intention of better showing the characteristics of the invention, a few preferred embodiments of a method and device according to the invention for producing a panorama book and a book-block of a panorama book and a folding apparatus for folding sheets in half used therein, are described hereinafter by way of an example, without any limiting nature, with reference to the accompanying drawings, wherein:

FIG. 1 schematically shows a perspective view of a folding apparatus according to the invention;

FIG. 2 shows a side view of the folding apparatus of FIG. 1;

FIGS. 3 and 4 schematically show the use of the folding apparatus of FIGS. 1 and 2 for folding a sheet in half;

FIGS. 5 and 6 schematically show a perspective view of an aligning plate and a pressure plate of an aligning apparatus of a device according to the invention;

FIGS. 7 to 10 schematically show different steps of a method for producing a book-block of sheets folded in half laminated on one another for a panorama book;

FIG. 11 schematically shows a perspective view of a positioning element of a device according to the invention;

FIGS. 12 to 14 schematically show different steps of a method for producing a panorama book starting with a book-block of FIG. 10.

### DETAILED DESCRIPTION OF THE INVENTION

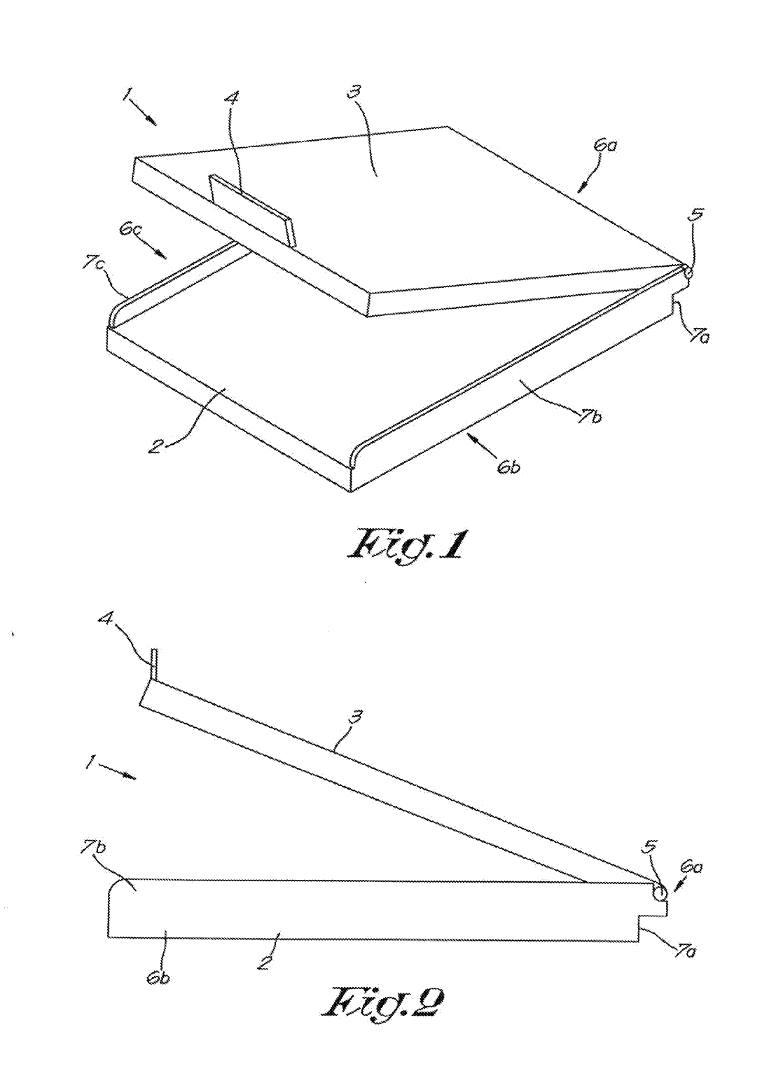

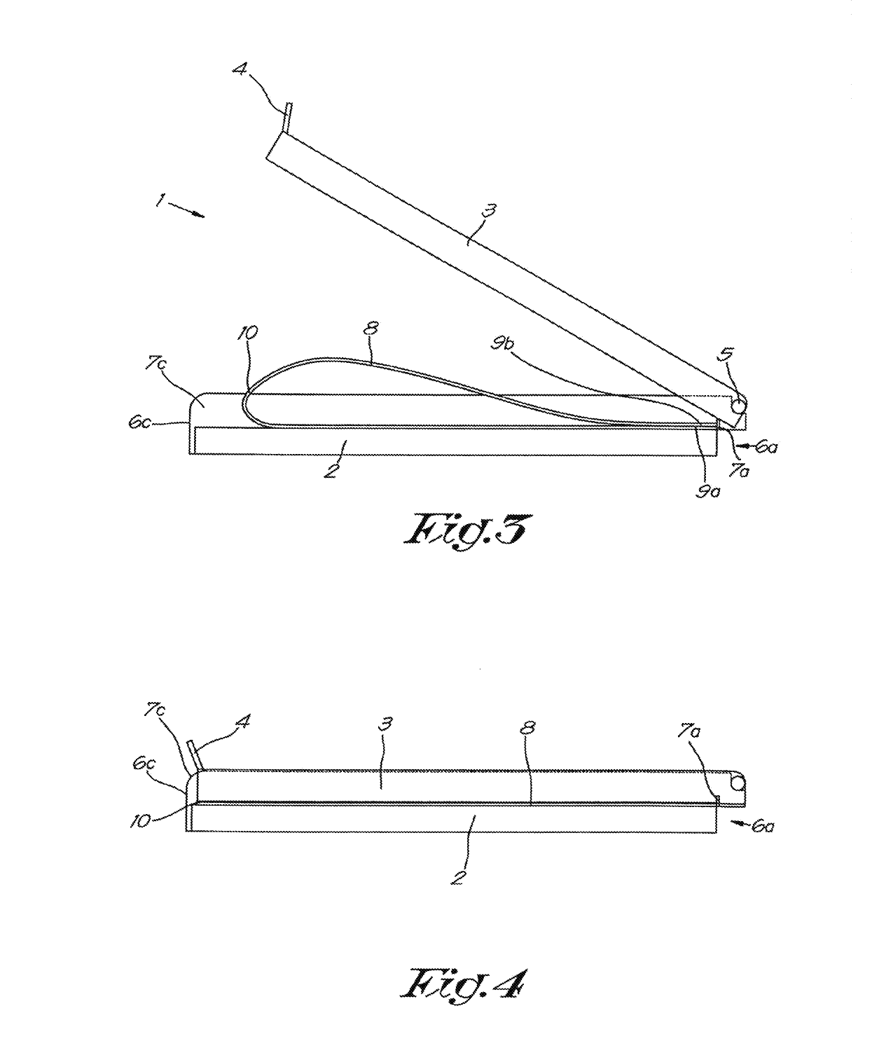

The folding apparatus 1 shown in FIGS. 1 and 2 essentially comprises a baseplate 2 and a pressing element 3.

In this case the pressing element 3 is constructed as a flat plate that is provided with a handle 4.

In this case the pressing element 3 is fastened on a side 6a of the baseplate 2 by means of a hinge.

The baseplate 2 is provided with end stops 7a, 7b, 7c to align or correctly position a sheet 8 to be folded in half.

A first end stop 7a is located on the side 6a of the baseplate 2 where the pressing element 3 is located, whereby this end stop 7a extends parallel to the hinge 5.

By placing the sheet 8 with an edge 9a and the opposite edge 9b against the end stop 12a, it can be ensured that the location of the fold 10 is always in the centre of the sheet 8.

In this case there are two additional end stops 7b, 7b on either side of the baseplate 2 that extend perpendicular to the aforementioned end stop 7a. All three end stops 7a, 7b, 7c are constructed as upright ribs 7a, 7b, 7c on three sides 6a, 6b, 6c of the baseplate 2.

In this case the upright ribs 7a, 7b, 7c, together with the baseplate 2, are constructed as a whole so that they form a tray or open container as it were, which can be clearly seen in FIG. 1.

It is clear that these two additional end stops 7b, 7c are not necessary.

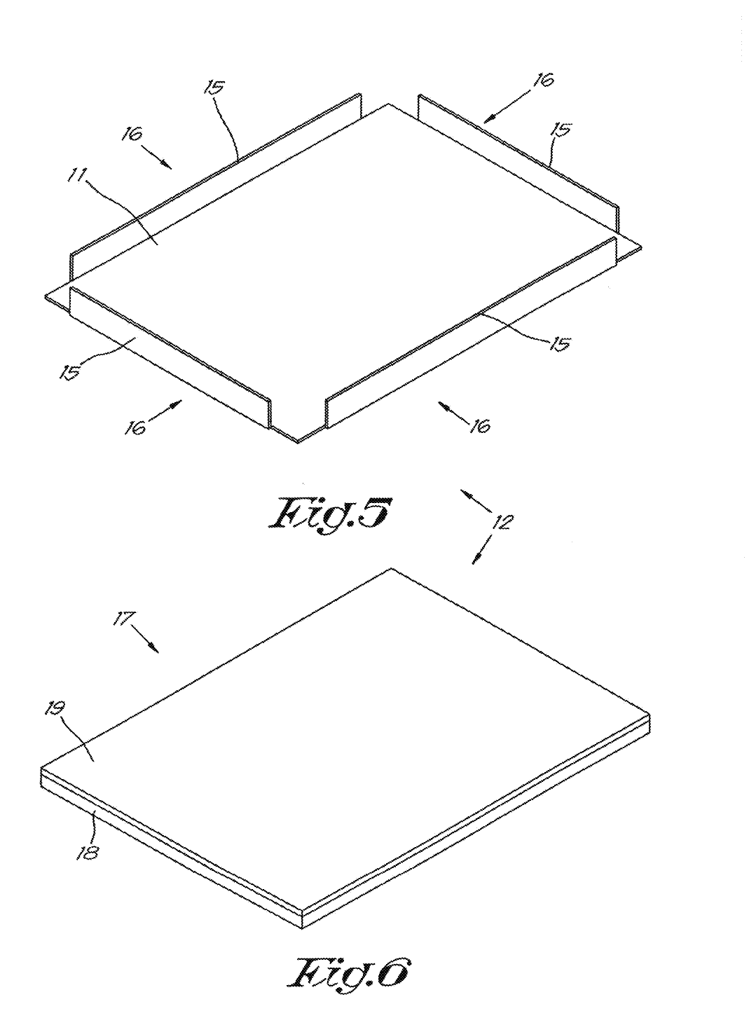

FIGS. 3 and 4 schematically show the use of a folding apparatus 1 according to the invention, or in other words a method for producing sheets 13 folded in half using this folding apparatus 1.

It starts with a sheet 8 to be folded, which when folded in half, is smaller than the dimensions of the baseplate 2. In other words the baseplate 2 is somewhat larger than a sheet 8 folded in half.

First a half of the sheet 8 to be folded in half is laid on the baseplate 2, ensuring that the sheet 8 is placed between the two additional end stops 7b, 7c and with an edge 9a against the first end stop 7a. This is shown in FIG. 3.

Using these three end stops 7a, 7b, 7c the sheet 8 to be folded in half can be aligned in at least two directions, with the advantage that successive sheets 8 are always laid on the baseplate 2 in exactly the same way.

Then the opposite edge 9b is placed against the end stop 7a by folding the sheet 8. This is shown in FIG. 3.

Then the pressing element 3 is brought to the baseplate 2, whereby the handle 4 can be used to make the flat plate tilt or turn. This is shown in FIG. 4.

Possibly in a subsequent step the pressing element 3 can be pressed at the location of the fold 10.

Because the baseplate 2 is somewhat larger than the sheet 8 folded in half, the fold 10 does not correspond to an edge of the baseplate 2 such that the fold 10 can be pressed.

The sheet 8 is thus folded in half with a sharp fold 10 that is exactly in the centre of the sheet 8.

Subsequent sheets 8 can be folded in half in a similar way, whereby the fold 10 will be formed in exactly the same location in all sheets 8.

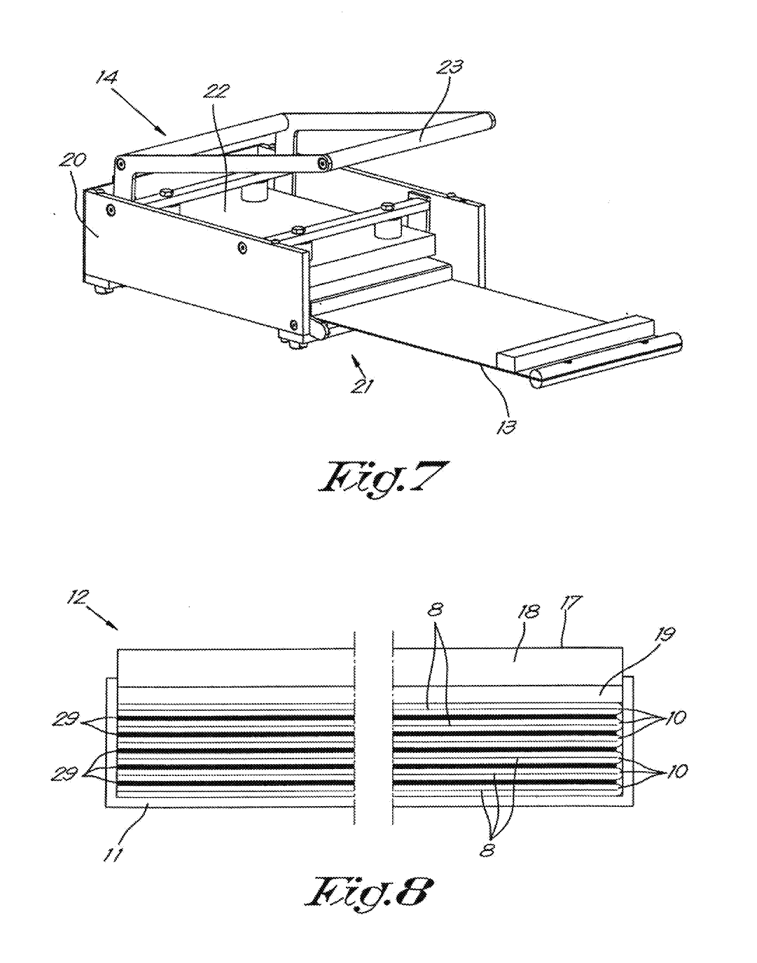

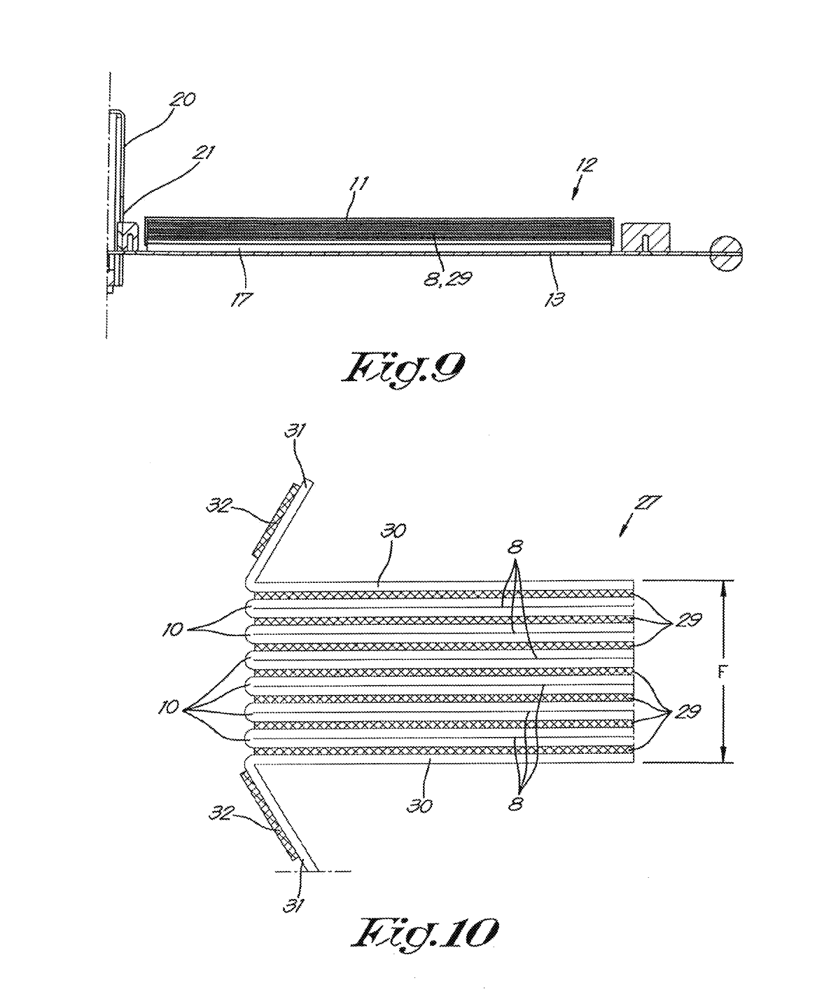

FIG. 5 shows an aligning plate 11 of an aligning apparatus 12 of a device according to the invention, that is suitable for being placed in the slide 13 of a laminating device 14, as shown in FIG. 7.

In this case, the aligning plate 11 is made of a thermally conductive material such as stainless steel for example, more specifically rustproof steel. The thickness of the aligning plate 16 is half a millimetre.

The aligning plate 11 is provided with a number of end stops 15, in this case four, one on each side 16 of the aligning plate 11.

In this case the end stops 15 are constructed as upright edges of the aligning plate 11 on the four sides 16 of the aligning plate 11. It is also possible that there is only an end stop 15 on one, two or three sides 16 of the aligning plate 11.

FIG. 6 shows the pressure plate 17 of an aligning apparatus 12 of a device according to the invention.

The pressure plate 17 consists of a hard plate 18 that is provided with a soft layer 19 on one side.

This soft layer 19 can be made of foam, rubber or another compressible material.

The hard plate 19 is preferably made of an insulating material.

The pressure plate 17 is intended to be affixed in the aligning plate 11.

The aligning plate 11 and the pressure plate 17, as shown in FIGS. 5 and 6, is placed in the slide 13 of the laminating device 14 of FIG. 7.

The laminating device 14 comprises the slide 13 that can be slid in and out of the housing 20 of the laminating device 14 via an opening 21 in the housing 20. Furthermore, the laminating device 14 comprises a hotplate 22 that is height-adjustable in the housing 20, in this case using a handle 23.

The folding apparatus 1 as shown in FIGS. 1 and 2, the aligning plate 11 of FIG. 5, the pressure plate 17 of FIG. 6 and a laminating device 14 of FIG. 7 are used in a method according to the invention for producing a book-block 27 of sheets folded in half laminated on one another for a panorama book 28.

In a first step of the method the sheets 8 folded in half are produced for the book-block 27 using the folding apparatus 1.

This starts, for example, with printed sheets with dimensions of a double page of the panorama book 28. For example, the illustration or photograph on the sheets 8 hereby extends over the entire sheet 8.

The production of sheets 8 folded in half using the folding apparatus 1 is done according to the above-mentioned steps, as shown in FIGS. 3 and 4. Briefly summarised these are the following steps:
the placing of half of a sheet 8 to be folded in half on the baseplate 2 of the folding apparatus 1 with an edge 9a against the end stop 7a;
the placing of the opposite edge 9b against the end stop 7a by folding the sheet 8 over;
bringing the pressing element 3 towards the baseplate 2 so that the sheet 8 is folded in half and a fold 10 occurs;
if desired the pressing of the pressing element 3 at the location of the fold 10.

These three steps are repeated as often as necessary until the desired or necessary number of sheets 8 folded in half has been produced.

In this way the sheets 8 are folded exactly in the centre and always exactly the same.

In a next step, as shown in FIG. 8, the sheets 8 folded in half are laid in the aligning plate 11, each time with a film 29 between two successive sheets 8 folded in half. This film 29 is provided on both sides with a layer of hotmelt adhesive.

It is hereby ensured that the sheets 8 and the films 29 are aligned with respect to one another on one another and that the folds 10 of the sheets 8 folded in half are oriented towards one another or are on one another.

As the aligning plate 11 is provided with end stops 15, the aligning will be done automatically when the sheets 8 are placed between the end stops 15 of the aligning plate 11.

Then the pressure plate 17 is placed in the aligning plate 11 on the sheets 8 folded in half, whereby the soft layer 19 is oriented towards the sheets 8. At the same time it is ensured that the pressure plate 17 is aligned with the sheets 8 by means of the end stops 15. This is shown in FIG. 8.

As can be seen in FIG. 8, the thickness of the pressure plate 17 and the height of the end stops 15 are preferably such that when the pressure plate 17 is laid on the bundle of sheets 8 folded in half, the pressure plate 17 comes above the edge of the end stops of the aligning plate 11.

Then the whole of the aligning apparatus 12 with the sheets 8 and films 29 are placed in the slide 13 of the laminating device 14, ensuring that the pressure plate is placed against the base of the slide 13.

In other words, the set as shown in FIG. 8 is placed upside down in the slide 13, as shown in FIG. 9.

Then the slide 13 is brought into the laminating device 14 and the lamination can be done in the known way by bringing the hotplate 22 downwards.

The hotplate 22 will hereby make contact with the aligning plate 11. Because the aligning plate 11 is made of a thermally conductive material, the heat generated by the hotplate 22 will be passed on to the films 29.

The effect of this will be that the hotplate 22 will heat up the films 29, such that the hotmelt adhesive will melt.

Because the pressure plate 17 ends up above the end stops 15 of the aligning plate 11, the hotplate 22 will be able to compress the soft layer 19 of the pressure plate 17. In this way it is ensured that the hotplate 22 can exert sufficient pressure on the bundle of sheets 8 in the aligning plate 11 without the end stops 15 preventing this.

In this way the sheets 8 will be bonded or laminated to one another back-to-back.

Because the hard plate 18 of the pressure plate 17 is made of an insulating material, there will be little to no heat loss along this hard plate 18. In other words, all or practically all heat generated by the hotplate 22 can be usefully used to melt the hotmelt adhesive.

The hotplate 22 is lifted upwards and the slide 13 is again slid out of the laminating device 14.

It is possible that a cooling plate is affixed on the aligning plate 11 and thus on the sheets 8. This cooling plate will enable the hotmelt adhesive to solidify and ensure that the sheets 8 remain nicely flat. Preferably this cooling plate is sufficiently heavy so that the cooling plate will exert sufficient force through its weight to keep the sheets flat.

Then the aligning plate 11 with the sheets 8 folded in half laminated to one another and the pressure plate 17 are taken out of the slide 13.

It is clear that it is also possible that the cooling plate is only placed on the sheets 13 after this step. It is important here that the cooling plate is affixed on the aligning plate 11 and not on the pressure plate 17.

Then the book-block 27 produced can be taken from the aligning plate 11.

Because the sheets 8 can be exactly aligned and because the folds 10 in the sheets are perfectly in the centre and identical for all sheets 8, the thus obtained book-block 27 of sheets 8 laminated on one another back-to-back will be perfectly finished so that post-cutting is not necessary. On the contrary, the book-block 27 will be so good and precisely finished that it will seem as if it has been post-cut, which is not the case however.

Preferably the hotmelt adhesive has a melting temperature of a maximum of 90° C., whereby the hotplate 22 will heat up to the melting temperature of the adhesive or somewhat hotter. This has the advantage that the colours of the illustration or photograph on the sheets 8 cannot run as a result of the heat of the hotplate 22. It is known that with some printing techniques, the colours can run at a temperature of more than 90 to 100° C., such that the quality and aesthetic appearance of the finished product will be reduced.

Preferably the book-block 27 is produced using hotmelt adhesive instead of a cold adhesive for example, because a cold adhesive creates moisture problems.

Preferably the book-block 27 obtained is provided with at least one endpaper 30 with a folded-back section 31 that is provided with an adhesive strip 32.

The adhesive strip 32 can be provided with a removable covering film or similar, for example, when the adhesive strip 37 comprises a self-adhesive glue.

The example of FIG. 10 shows that the book-block 27 is provided with two endpapers 30, one of which folded-back section 31 has the dimensions of half of a sheet 8 to be folded in half and one of which folded-back section 31 is a narrow strip.

It is clear that two endpapers 30 with a narrow strip can also be used or two endpapers 30, of which the folded-back section 31 is as large as half of a sheet 8 to be folded in half.

Practice has shown that an endpaper 30 with a narrow strip as a folded-back section 31 always leaves behind a marking on the book-block 27. That is why it is chosen to use endpapers 30 of which the folded-back section 31 has the dimensions of half of a sheet 8 to be folded in half.

For the same reason it is chosen that the adhesive strip 32 is constructed with a limited thickness.

In both cases the adhesive strip 32 is situated at the location of the fold 10 of the sheets 8.

In order to provide the book-block 27 with an endpaper 30, use can be made of two different methods.

Either the book-block 27 can be provided with an endpaper 30 after it has been taken out of the aligning plate 11 after laminating the sheets 8 folded in half to one another.

Or the book-block 27 can be provided with an endpaper 30 during the method for producing a book-block 27 by taking at least one of the following steps:
for laying the sheets 8 folded in half in the aligning plate 11, laying a first endpaper 30 with a film 29 thereon in the aligning plate 11;
for placing the pressure plate 17, laying a film 29 and a second endpaper 30 in the aligning plate 11.

By applying this method the endpapers 30 will be exactly or as good as exactly aligned with the sheets 8 folded in half with endpapers 30 that have exactly the same sizes as the sheets 8 folded in half.

Then the method can be continued as described above.

For finishing the final panorama book 28 the book-block 27 obtained can be placed in a hard cover 33 and bonded therein.

To ensure that the book-block 27 is exactly positioned in the hard cover 33, use is made of a positioning element 34 that comprises a positioning plate 35 that is provided on opposite edges 36 with protruding ribs 37. The distance A between these ribs is equal to the width B of the hard cover 33.

On one side of the positioning plate 35, the transition from the positioning plate 35 to the protruding ribs 37 is stepped, whereby the distance C between the steps 38 is equal to the width D of the book-block 27.

In this case and preferably the height E of the protruding ribs 37 on the side with the stepped transition is greater than the thickness F of the book-block 27. In this case, but not necessarily, the thickness G of the steps is approximately equal to the thickness F of the book-block 27. It is also possible that the thickness G is somewhat smaller than the thickness F of the book-block 27.

In this case, but not necessarily, the positioning plate 35 is provided with an end stop 40 on one edge 39 that extends transversely on the ribs 37, on the side of the positioning plate 35 with the stepped transition.

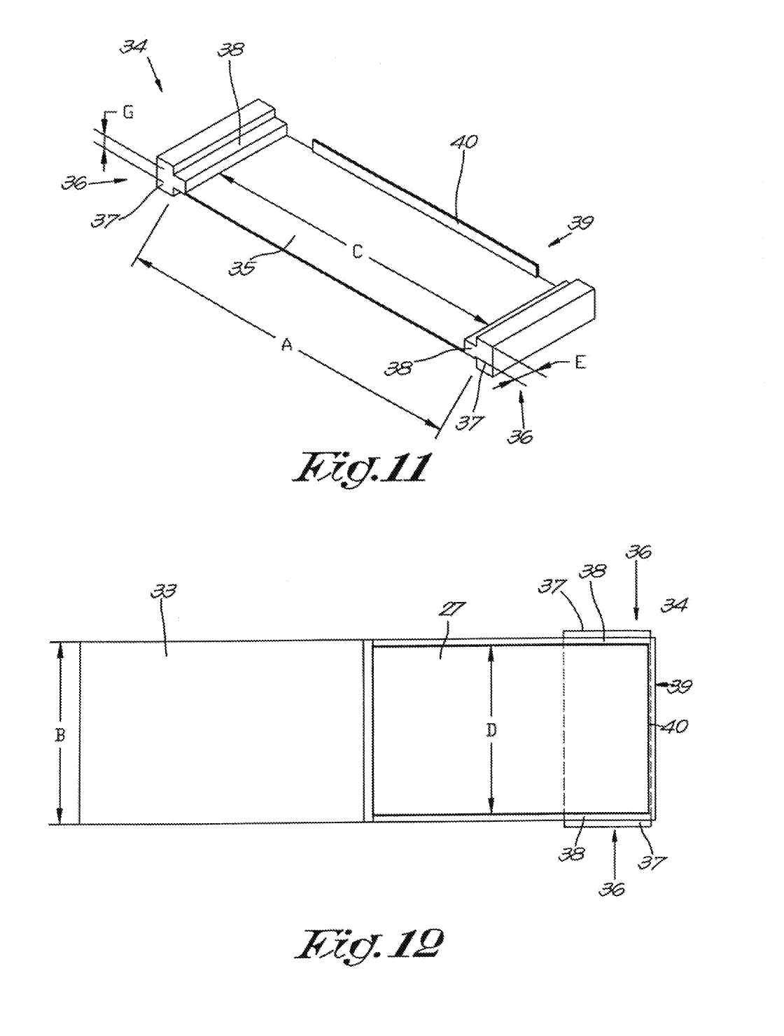

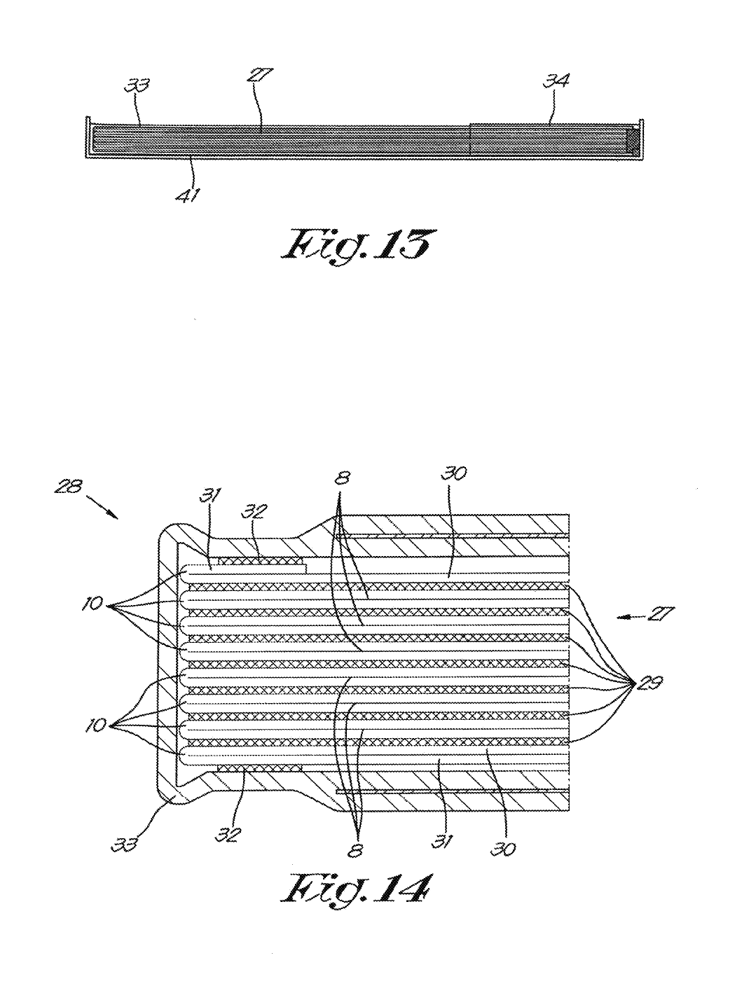

The method for producing a panorama book 28 starting with a book-block 27 as shown in FIG. 10 and a hard cover 33, and making use of a positioning element 34, as shown in FIG. 11, is shown in FIGS. 12 and 13.

First of all the hard cover 33 is opened and the positioning element is placed on the hard cover 33, as shown in FIG. 12.

It is hereby ensured that the cover 33 is between the protruding ribs 37 and that the side with the stepped transition is upwards and that the edge 39 of the positioning plate 35 is aligned with an edge of the cover 33.

Then the book-block 27 is introduced, ensuring that the book-block 27 is between the steps 38.

In this case the book-block 27 is placed against the end stop 40. In this way the book-block 27 is positioned in two directions with respect to the hard cover 33.

Then the hard cover 33 is closed and it is all placed in an open tray 41 whose dimensions correspond to the dimensions of the hard cover 33.

The book-block 27 can then be fastened in the hard cover 33 by means of at least one adhesive strip 32 that is provided with an endpaper 30 of the book-block 27.

It is clear that these adhesive strips 32 can also be on an inside page of the hard cover 33, for example when the book-block 27 is not finished with endpapers 30 or when the endpapers 30 are not provided with adhesive strips 32. This is also to be chosen when the adhesive strips 32 cannot be made thin.

In order to fasten the book-block 27 in the hard cover 33 the following steps can be taken:
the opening of the hard cover 33 and the removal of a removable covering film from the adhesive strip 32 on an endpaper 30 of the book-block 27;
the closing of the hard cover 33 so that the adhesive strip 32 can stick the book-block 27 in the hard cover 33.

As a second adhesive strip 32 is provided in this case, the set is taken out of the open tray 41 and placed back in the tray upside down. It is hereby ensured that the positioning element 34 does not move with respect to the hard cover 33 and the book-block 27.

Then the two steps mentioned above can be repeated again so that the second adhesive strip 32 can bond the book-block 27 in the hard cover 33.

It is clear that due to the method described above and making use of the positioning element 34, the book-block 27 can be fastened exactly or as good as exactly in the hard cover 33.

In the way described above, with all its variations, a very nice, quality and perfectly finished panorama book 28 can be obtained that looks very professional, without making use of large, expensive, relatively hazardous and difficult-to-operate machines. On the contrary, the folding apparatus 1, the positioning element 34, and the aligning apparatus 12 of the device according to the invention are compact, cheap, safe and simple to use. This also applies to the laminating device 14. This will enable professional quality products to be produced in small areas or in a commercial environment. Its use by individuals is also among the possibilities.

It is also clear that a book-block 32 can be produced using only the device according to the invention consisting of the folding apparatus 1, a positioning element 34 and the aligning apparatus 12, when a self-adhesive glue is used, for example, so that heating is not necessary. After folding the sheets 8 in half with the folding apparatus 1, the sheets 13 can then be laid on the aligning plate 11 with the necessary self-adhesive glue between them and are nicely aligned between the end stops 15, after which pressure can be exerted on the set using the pressure plate 17 or similar, for example. The plate will come between the end stops 15 and thus can exert pressure on the sheets 8 folded in half to make the connection between the sheets 8. The book-block 27 thus obtained will appear very nice, perfectly aligned and professional.

The present invention is by no means limited to the embodiments described as an example and shown in the drawings, but a method and device according to the invention for producing a panorama book and a book-block of a panorama book and a folding apparatus for folding sheets in half used therein can be realised in all kinds of variants without departing from the scope of the invention.

Another aspect of the invention concerns an aligning apparatus for a laminating device (14) for producing a book-block (27) of sheets (8) folded in half laminated on one another, whereby the laminating device (14) is provided with a slide (13) in which sheets (8) folded in half can be placed and a hotplate (22) that can be lowered, whereby the aligning apparatus (12) comprises an aligning plate (11) with end stops (15) for aligning sheets (8) folded in half with respect to one another on one another, whereby this aligning plate (11) is suitable to be affixed in the slide (13) and a pressure plate (17) consisting of a hard plate (18) that is provided on one side with a soft layer (19), whereby the pressure plate (17) is suitable to be affixed in the aligning plate (11).

Preferably the aligning plate (11) is made of a thermally conductive material such as stainless steel or rustproof steel, for example.

Preferably the aligning plate (11) is half a millimetre thick.

Preferably the end stops (15) of the aligning plate (11) are constructed as upright edges of the aligning plate (11) on one or more sides (16) of the aligning plate (11).

Preferably all four of the sides (16) of the aligning plate (11) are provided with an upright edge.

Preferably the soft layer (19) of the pressure plate (17) is made of foam, rubber or another compressible material.

Preferably the hard plate (18) of the pressure plate (17) is made of an insulating material.

Preferably the thickness of the pressure plate (17) and the height of the end stops (15) are such that when the pressure plate (17) is laid on a bundle of sheets (8) folded in half, that are placed in the aligning plate (11), the pressure plate (17) comes above the edge of the end stops (15) of the aligning plate (11).

Another aspect of the invention concerns a positioning element for positioning a book-block (27), produced according to the invention for producing a panorama book (28), in a hard cover (33), whereby the positioning element (34) comprises a positioning plate (35) that is provided with protruding ribs (37) on two opposite edges (36), whereby the distance (A) between the protruding ribs (37) is equal to the width (B) of the hard cover (33), whereby on one side of the positioning plate (35) the transition from the positioning plate (35) to the protruding ribs (37) is stepped, whereby the distance (C) between the steps (38) is equal to the width (D) of the book-block (27).

Preferably the height (E) of the protruding ribs (27) on the side with the stepped transition is greater than the thickness (F) of the book-block (27).

Preferably the thickness (G) of the steps (38) is approximately equal to or somewhat smaller than the thickness (F) of the book-block (27).

Preferably the positioning plate (35) is provided with an end stop (40) on one edge (39) that extends transversely on the ribs (37), on the side of the positioning plate (35) with the stepped transition.

1. A folding apparatus for folding sheets in half (8), wherein the folding apparatus (1) comprises a baseplate (2) with an end stop (7a, 7b, 7c) for aligning a sheet (8) to be folded and a pressing element (3) that is movable with respect to the baseplate (2) in order to enable a sheet (8) to be folded in half, that is placed with two opposite sides against the end stop (7a, 7b, 7c), by bringing the pressing element (3) to the baseplate (2) in order to make such a fold (10).

2. Folding apparatus according to claim 1, wherein the pressing element (3) is constructed as a flat plate that is fastened to the baseplate (2) by means of a hinge (5) or similar.

3. Folding apparatus according to claim 2, wherein the end stop (7a) is at the location of the hinge (5).

4. Folding apparatus according to claim 1, wherein the baseplate (2) is provided with end stops (7a, 7b, 7c) for aligning a sheet (8) to be folded in half in at least two directions.

5. Folding apparatus according to claim 3, wherein the end stops (7a, 7b, 7c) are constructed as upright ribs (7a, 7b, 7c) on one, two or three sides (6a-6c) of the baseplate (2).

6. Folding apparatus according to claim 5, wherein the upright ribs (7a, 7b, 7c) and the baseplate (2) form a tray or open container, as it were.

7. Folding apparatus according to claim 1, wherein, the pressing element (3) is provided with a handle (4) or similar to be able to move the pressing element (3) with respect to the baseplate (2).

8. Method for producing a book-block (27) of sheets (8) folded in half laminated on one another for a panorama book (28), wherein use is made of a folding apparatus (1) according to claim 1 for folding sheets in half (7), and a laminating device (14) that is provided with a hotplate (22) that can be lowered and a slide (13) in which an aligning plate (11) can be affixed with end stops (15) for aligning sheets (8) folded in half with respect to one another and with a pressure plate (17) consisting of a hard plate (18) that is provided on one side with a soft layer (19), whereby the method comprises the following steps:
the production of the sheets (8) folded in half for the book-block (27) using the folding apparatus (1);
the laying of the sheets (8) folded in half in the aligning plate (11) with a film (29) between two successive sheets (8) folded in half each time, whereby this film (29) is provided on both sides with a layer of hotmelt adhesive, ensuring that the sheets (8) and films (29) are aligned with respect to one another on one another using the end stops (15);
the placing of the pressure plate (17) in the aligning plate (11) with the soft layer (19) towards the sheets (8), ensuring that the pressure plate (17) is aligned with the sheets (8) folded in half using the end stops (15);
the placing of the aligning plate (11) with the sheets (8) folded in half, films (29) and pressure plate (17) in the slide (13) of the laminating device (14), ensuring that the pressure plate (17) is placed against the base of the slide (13);
the lowering of the hotplate (22), whereby the hotplate (22) makes contact with the aligning plate (11), so that the hotmelt adhesive melts and the sheets (8) folded in half are laminated on one another;
the raising of the hotplate (22) back upwards;
taking the aligning plate (11) with the sheets (8) folded in half (13) laminated to one another and the pressure plate (17) out of the slide (13);
the removal of the book-block (27) produced from the aligning plate (11).

9. Method according to claim 8, wherein the step of producing the sheets (8) folded in half for the book-block (2) using the folding apparatus (1) comprises the following steps:
the placing of a half of a sheet (8) to be folded in half on the baseplate (2) of the folding apparatus (1) with an edge (9a) against the end stop (7a);
the positioning of the opposite edge (9b) against the end stop (7a) by folding back the sheet (8);
bringing the pressing element (3) to the baseplate (2) so that the sheet (8) is folded in half and a fold (10) occurs;
if desired the pressing of the pressing element (3) at the location of the fold (10);
repeating the previous steps as often as necessary until the desired or necessary number of sheets (8) folded in half has been produced.

10. Method according to claim 8, wherein the book-block (27) is provided with at least one endpaper (30) with a folded-back section (31) that is provided with an adhesive strip (32), provided or otherwise with a removable covering film or similar.

11. Method according to claim 10, wherein the folded-back section (31) has the dimensions of half of a sheet (8) to be folded in half or that the folded-back section (31) is a narrow strip.

12. Method according to claim 10, wherein to provide the book-block (27) with at least one endpaper (30) the method at least comprises one of the following steps:
for laying the sheets (8) folded in half in the aligning plate (11), laying a first endpaper (30) with a film (29) thereon in the aligning plate (11);
for placing the pressure plate (17), laying a film (29) and a second endpaper (30) in the aligning plate (11).

13. Method according to claim 10, wherein the book-block (27) is provided with an endpaper (30) after it has been taken from the aligning plate (11).

14. Method according to claim 8, wherein after the step of lifting the hotplate (22) back up or taking the aligning plate (11) with the sheets (8) folded in half and the pressure plate (11) out of the slide (13), the sheets (8) are cooled by means of a cooling plate that is laid on the sheets (8).

15. Method for producing a panorama book (28) starting with a book-block (27) produced according to claim 8 and a hard cover (33), and making use of a positioning element (34) that comprises a positioning plate (35) that is provided on two opposite edges (36) with protruding ribs (37), whereby the distance (A) between the protruding ribs (37) is equal to the width (B) of the hard cover (33), whereby on one side of the positioning plate (35) the transition from the positioning plate (35) to the protruding ribs (37) is stepped, whereby the distance (C) between the steps (38) is equal to the width (D) of the book-block (37), whereby one edge (39) of the positioning plate (35) that extends transversely on the ribs (37) may be provided with an end stop (40), on the side of the positioning plate (35) with the stepped transition, wherein the method comprises the following steps:
the opening of the hard cover (33);
the placing of the positioning element (34) on the hard cover (33), ensuring that the cover (33) is between the protruding ribs (37), with the side with the stepped transition oriented upwards, and that an edge (39) of the positioning plate (35) is aligned with an edge of the hard cover (33);
the introduction of the book-block (27), ensuring that the book-block (27) is between the steps (38) and that the book-block (27) comes against the end stop (40) if need be;
the closing of the hard cover (33) and placing the set in an open tray (41) whose dimensions correspond to the hard cover (33);
the fastening of the book-block (27) in the hard cover (33) by means of at least one adhesive strip (32) that is provided either on an endpaper (30) of the book-block, or on an inside page of the hard cover (33).

16. Method according to claim 15, wherein to fasten the book-block (27) in the hard cover (33) the following steps are taken:
the opening of the hard cover (33) and the removal of a removable covering film of the adhesive strip (32) on an endpaper (30) of the book-block (27) or on an inside page of the hard cover (33);
the closing of the hard cover (33) so that the adhesive strip (32) can bond the book-block (27) in the hard cover (33);
if a second adhesive strip (32) is provided on the other inside page or on another endpaper (30), taking the set out of the open tray and placing it back in the tray upside down, ensuring that the positioning plate (35) does not move with respect to the hard cover (33) and the book-block (27) and repeating the previous two steps so that the second adhesive strip (32) can bond the book-block (27) in the hard cover (33).

17. Method according to claim 15, wherein use is made of a cover (33) with at least one adhesive strip (32) on at least one inside page of the cover (33) and of a book-block (27) without endpapers (30) or with endpapers (30) that are not provided with an adhesive strip (32).

18. Device for producing a panorama book, wherein the device is provided with:
a folding apparatus (1) according to claim 1 for folding sheets in half (7);
an aligning apparatus (12) for aligning sheets (8) folded in half on one another to form a book-block (27), whereby this aligning apparatus (12) comprises an aligning plate (11) with end stops (15) for aligning sheets (8) folded in half with respect to one another on one another, and a pressure plate (17) consisting of a hard plate (18) that is provided with a soft layer (19) on one side, whereby the pressure plate (17) is suitable for being introduced in the aligning plate (11); and
a positioning element (34) for positioning the book-block (27) in a hard cover (33), whereby this positioning element (34) comprises a positioning plate (35) that is provided with protruding ribs (37) on two opposite edges (36), whereby the distance (A) between the protruding ribs (37) is equal to the width (B) of the hard cover (33), whereby on one side of the positioning plate (35) the transition from the positioning plate (35) to the protruding ribs (37) is stepped, whereby the distance (C) between the steps (38) is equal to the width (D) of the book-block (27), whereby one edge (39) of the positioning plate (35) that extends transversely on the ribs (37) is provided with an end stop (40) if need be, on the side of the positioning plate (35) with the stepped transition.
